(19) United States
(12) Patent Application Publication
(10) Pub. No.: US 2004/0149639 A1
(43) Pub. Date: Aug. 5, 2004

(54) Apparatus for mixing and dispensing influent slurry into a tank and systems incorporating same

(76) Inventors: Vaughn J. Weston, Kearns, UT (US); Robert Kent Brown, Salt Lake City, UT (US); John Banning Johnson II, Sandy, UT (US); Donald C. Taylor, Salt Lake City, UT (US)

Correspondence Address: TRASK BRITT, P.O. BOX 2550, SALT LAKE CITY, UT, 84110, US

(21) Appl. No.: 10/714,535

(22) Filed: Nov. 14, 2003

Related U.S. Application Data
(60) Provisional application No. 60/426,600, filed on Nov. 15, 2002.

(51) Int. Cl. B01D 21/08

(52) U.S. Cl. 210/208; 210/520; 210/528

(57) ABSTRACT

An apparatus for mixing and dispensing an influent slurry into a tank. The apparatus may include a body having a sidewall and floor which together define a volume for the slurry to pass through. Fixed baffles and rotating paddles may be disposed within the body in an interleaved manner to promote mixing of the slurry with a flocculating reagent. The apparatus may also include scrapers for reducing built-up floc on the walls and/or floor of the apparatus. The floor of the apparatus may define a constricted opening for discharge of the slurry. The constricted opening, which serves to control the flow of the slurry through the body of the apparatus, also helps to increase mixing time of the slurry with the flocculating reagent. The constricted opening may be configured as an annular or ring-shaped port.

### CROSS-REFERENCE TO RELATED APPLICATIONS

This application claims the benefit of U.S. Provisional Patent Application Serial No. 60/426,600, filed Nov. 15, 2002 for APPARATUS FOR MIXING AND DISPENSING INFLUENT SLURRY INTO A TANK AND SYSTEMS INCORPORATING SAME.

### BACKGROUND OF THE INVENTION

1. Field of the Invention

The present invention relates generally to the separation of liquid and solid components of slurry and, more specifically, to a feedwell apparatus employed in, for example, a clarifier tank for thoroughly mixing a flocculating reagent with the slurry and dispensing the slurry into the tank.

2. State of the Art

A variety of industries use clarifier tanks to separate an influent feed slurry (i.e., a liquid carrying suspended particles) into a supernatant “clarified” liquid phase having a lower concentration of particles than the influent feed slurry, and an underflow stream having a higher concentration of particles than the influent feed slurry, the underflow stream being in the form of a sludge or thickened mud on the bottom of the tank. The sludge may then be collected and disposed of or subjected to further processing. Likewise, the clarified liquor may be collected for further processing or disposal, or may be reused, for example, to assist in similar separation processes.

Many clarifiers are constructed with a feedwell which is conventionally a volume or compartment within a tank but which is substantially separated from the general contents of the tank. The feedwell allows the introduction of the influent feed slurry into the tank in a nonturbulent manner. The reduction, or elimination, of turbulence within the slurry prior to its introduction into the clarifier tank serves to minimize disruption of the thickened material which has settled on, or is settling to, the floor of the tank. Undue disruption of the sludge causes particles to become suspended, or rather resuspended, within the supernatant liquid and results in an inefficient sedimentation process. As the sludge settles and collects on the floor of the tank, a rotary rake arm, conventionally provided within the tank adjacent the floor, may move the sludge or sediment along the bottom of the tank to an underflow discharge location.

A flocculent may be added to the influent slurry before the slurry enters the clarifier tank. The flocculent causes the suspended particles to agglomerate, enabling them to more readily settle. The flocculating reagent conventionally has a polymeric molecular structure which agglomerates with suspended particles in the influent to form aggregate clusters referred to as flocs. While the use of a flocculating reagent may be beneficial in the sedimentation or clarification process, various factors may affect its efficiency. For example, the concentration of suspended solid particles within the slurry must be taken into account.

Additionally, the level of mixing to which the flocculating reagent and the influent slurry are subjected may also affect the growth of the flocs. Thorough mixing helps to ensure adequate interaction between the suspended particles and the flocculating reagent. However, the energy added to the slurry within the feedwell by way of mixing may be undesirably transferred to the clarifying or settling zone of the clarifier as the slurry exits the feedwell. As noted above, it is generally desirable to reduce the energy of the stream prior to its introduction into the tank in order to promote settling of the flocs. Thus, excessive mixing or overly aggressive mixing may serve to nullify any energy dissipation efforts. It is often, therefore difficult to ensure adequate mixing of the flocculating reagent with the influent slurry while controlling the energy of the slurry stream so as to ensure adequate settling of the flocs.

Another problem associated with the use of feedwells is that particles may begin settling prior to the slurry being discharged therefrom, resulting in built-up floc material on the floor and walls within the feedwell. This, in turn, affects the flow characteristics within the feedwell, making it difficult to obtain the desired mixing, flow and distribution of the slurry into the tank.

Additionally, in an effort to dissipate energy of the influent slurry stream, feedwells are conventionally configured with open bottoms and, often, are flared or “bell-shaped” at their bottom portions. While such configurations may help to dissipate energy associated with the influent slurry stream, flow and discharge of the slurry into the clarifier tank is not adequately controlled. Furthermore, such open-bottomed feedwells do not always provide adequate residence time of the slurry within the feedwell for complete mixing.

In view of the shortcomings in the art, it would be advantageous to provide a method and apparatus to provide an enhanced settling process including thoroughly mixing the flocculating reagent with the influent stream of slurry, preventing floc build up within the feedwell, and introducing the feed stream into the clarifier tank in a controlled manner. Enhancing the growth of flocs as well as the settling process will achieve a high throughput of solids, increased solids recovery, and a higher clarity of liquor, thereby reducing or even eliminating the need for further clarification or filtration.

### BRIEF SUMMARY OF THE INVENTION

The present invention comprises a feedwell for use in a clarifier tank including one or more features promoting effective mixing of a flocculating reagent, formation of floc masses within the feedwell, reduced floc build up on the floor and walls of the feedwell, and for delivery of the feed stream to the clarifying zone of the clarifier. The feedwell of the present invention may be structured for delivery of the feed stream to an upper cone of the feedwell. Rotating paddles moving about fixed baffles may provide effective mixing, promoting floc growth. The baffles need not extend to the depth of the rotating paddles in which case a zone of less stimulation is provided within the lower portion of the feedwell. The floor of the feedwell may slope downward from its circumference to a central shaft, with an opening formed thereabout. Alternatively, the floor of the feedwell may include two sections with one extending outwardly and downwardly from the drive shaft and the second extending inwardly and downwardly from a sidewall to define an annular, or ring shaped, opening for discharge of the slurry into the clarifier tank. The openings, regardless of configuration, are generally constricted in cross-sectional area relative to a horizontal cross-sectional area of the feedwell so as to constrict flow of the slurry therethrough. Cleansing scrapers may be provided to sweep the floor and/or the walls of the feedwell, removing any settled particles or floc growth thereon. Additionally, cleansing scrapers may be provided to sweep through the discharge opening of the feedwell to prevent any bridging of the opening through unwanted build-up of floc therein.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a schematic view, in cross section, of a unit storage clarifier tank employing a feedwell in accordance with an embodiment of the present invention;

FIG. 2 is an enlarged view, in cross section, of the feedwell of FIG. 1;

FIG. 3 is a view in lateral cross section of the feedwell shown in FIG 2 taken at line 3-3, with scrapers turned from the position of FIG 2;

FIG. 4 is a cross-sectional view of a feedwell according to another embodiment of the present invention;

FIG. 5 is a cross-sectional view of a feedwell according to yet another embodiment of the present invention.

### DETAILED DESCRIPTION OF THE INVENTION

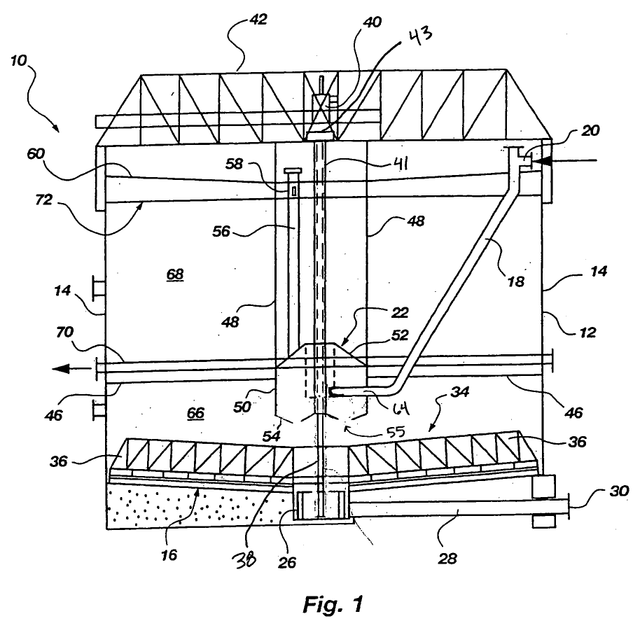

Referring to FIG. 1 a unit storage clarifier tank 10 is shown which may be used, for example, in the clarification of green liquor in a recausticizing process. Notably, a unit storage clarifier tank differs from a standard clarification tank by having storage capacity for clarified liquid, as described more fully below. The unit storage clarifier tank 10 includes a tank 12 having a wall 14 and a bottom 16 defining a volume within which a liquid containing a solids component is separated into clarified liquid and liquid/solid phases. An influent feed pipe 18 having an inlet 20 is positioned for directing an influent feed stream into the tank 12. More specifically, as shown in FIG. 1, the influent feed pipe 18 may be positioned to deliver the influent feed stream into a feedwell 22 to reduce the velocity of the influent feed stream prior to its introduction into the tank 12. The bottom 16 of the clarifier tank 10 may be inwardly and downwardly sloped, as illustrated, to facilitate movement of the sludge, or the liquid/solids phase of the separated influent, into a central opening 26 in the tank. In another embodiment, the tank bottom may be flat. The sludge, which in some applications may also referred to as “dregs”, are then removed from the tank 12 through an underflow pipe 28 and outlet 30. The movement of sludge in the tank 12 may also be facilitated by a rake assembly 34, which generally comprises one or more rake arms 36 which rotate about the central axis of the tank 12. The rake arms 36 are attached to a drive shaft 38, also referred to herein as the rake arm drive shaft, which is connected to a drive motor 40. The drive motor 40 may be positioned, for example, on a bridge 42 which spans the tank 12. A paddle drive shaft 41, which may also be referred to as a turbine or flocculator drive shaft, may be coaxial with, and concentrically disposed about, the rake arm drive shaft 38 and operably coupled to a paddle drive 43, which may also referred to as a turbine or flocculator drive. The paddle drive shaft 41 may be coupled to one or more structures associated with the feedwell 22 as described in greater detail below.

The feedwell 22 may be centrally located within the tank 12, and may be maintained in place within the tank 12, for example, by stabilizer rods or cables 46 which connect the feedwell 22 to the wall 14 of the tank 12 as well as by rods or cables 48 which suspend the feedwell 22 from the bridge 42. The feedwell 22 generally surrounds the rake arm drive shaft 38 which operates the rake assembly 34. The feedwell 22 is generally structured with a perimeter wall 50, a substantially closed top 52 and a bottom 54 having a generally constricted opening 55 (or openings) formed therein. The feedwell 22 may include a vent line 56 which allows entrained air to escape from the feedwell 22. The vent line 56 may be constructed with a vent opening 58 below the roof 60 of the tank 12 so that the air is vented into the tank 12 rather than to atmosphere because the vent line 56 may, in some conditions, act as an air lift.

It should be noted that feedwells used in unit storage clarifier tanks, such as that described above herein, are conventionally submerged below the intended or expected fluid line or level of the tank and have a substantially enclosed top which prevents substantial mixing of the clarified liquid disposed in the tank 12 with the influent slurry. By contrast, a feedwell employed in a standard clarifier tank (i.e., not a unit storage clarifier tank) is conventionally positioned near the top of the tank with the top of the feedwell being positioned at or above the intended or expected fluid line of the tank. Feedwells of conventional construction used in standard clarifier tanks, therefore, do not conventionally include an enclosed top or a vent line.

Still referring to FIG. 1, the influent feed pipe 18 may be connected to one or more nozzles 64 which deliver the influent feed into the feedwell 22. The velocity of the influent feed is redirected and reduced to some degree before passing through the constricted opening 55 of the feedwell 22 and into the tank 12. As the liquid in the tank 12 becomes more quiescent, the solids component of the influent slurry settles to the bottom 16 of the tank to form the sludge or dregs. Separation takes place in a clarification zone 66 of the tank 12 which, for example, may be generally located in the bottom one third volume of the tank 12. Clarified liquid is formed near the upper volume of the tank 12. A unit storage clarifier tank 10 further includes a clarified liquid storage zone 68, while a standard clarifier tank does not. Clarified liquid is removed from the tank 12 of a unit storage clarifier 10 through an effluent pipe 70 which may be located at any appropriate level of the clarified liquid storage zone 68. As illustrated in FIG. 1, the effluent pipe 70 may be located, for example, at a vertical midpoint of a unit storage clarifier tank 12. In a standard clarifier tank, the effluent pipe 70 is usually located nearer to the liquid level 72 of the liquid in the tank 12 and the effluent pipe 70 may be configured in the form of an overflow launder.

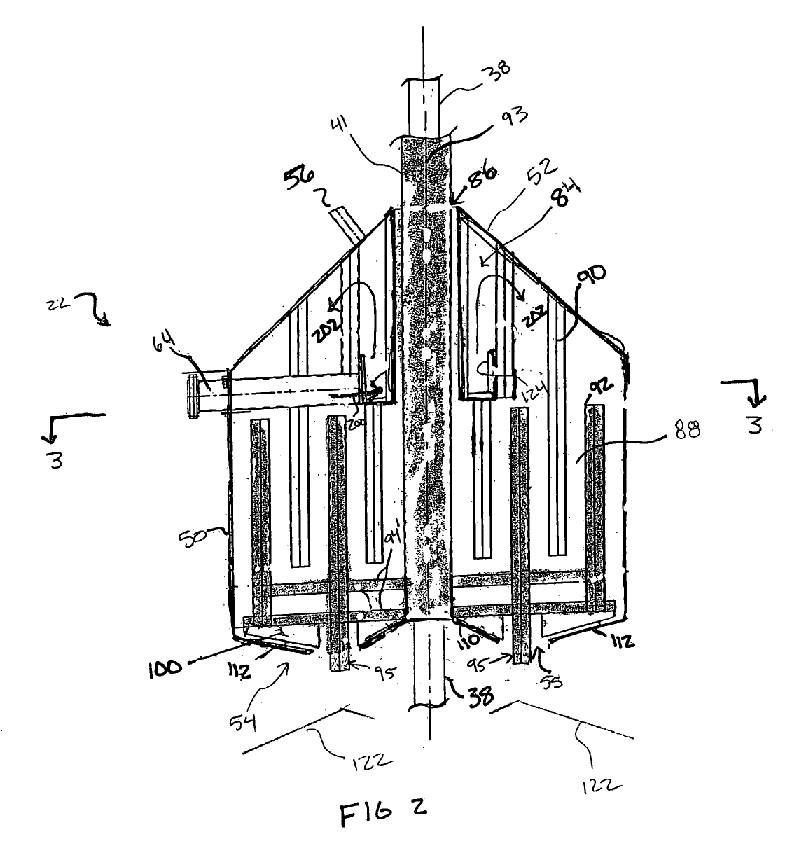

Referring now to FIG. 2, a cross-sectional view of an exemplary feedwell 22 is shown in accordance with the present invention. The feedwell 22 of the present invention may be constructed as an element of a new clarifier tank or may be adapted as a retrofitted element of an existing clarifier tank. Further, the feedwell 22 may be provided for use in either a standard clarifier tank, in which case the feedwell 22 is positioned near the top of the tank, or in a unit storage clarifier tank, in which case the feedwell is submerged and includes a substantially enclosed top, as described more fully below. The feedwell 22 includes a substantially continuous side wall 50 forming a generally cylindrical volume and a top wall 52 which, in the embodiment shown and described with respect to FIG. 2, forms a generally frustoconical volume 84. In one exemplary embodiment, the height of the side wall 50 of the feedwell 22 may be approximately six to eight feet, and the diameter of the feedwell 22 may be approximately ten feet, although other configurations are contemplated and such dimensions may depend on the particular application in which the feedwell 22 is employed as will be appreciated by those of ordinary skill in the art. The top wall 52 of the feedwell 22 may leave a small annular or ring-shaped opening 86 around the drive shafts 38 and 41 which is in communication with the fluid in the surrounding tank 12 (FIG. 1). It is noted that such an opening 86 is not detrimental to the proper functioning of the feedwell as described herein. In another embodiment, the top wall 52 of the feedwell 22 may be sealed to prevent communication between any fluid the clarifier tank 10 and the upper end of the feedwell 22.

The side wall 50 of the feedwell 22 defines a volume which may be termed the main flocculation zone 88. While the embodiment shown in FIG. 2 depicts the side wall 50 as being substantially vertical, thereby forming a substantially cylindrical shape, the side wall 50 may be angled to form a substantially conical or bell-shaped volume for the main flocculation zone 88.

Within the feedwell 22, stationary baffles 90 may extend from the top wall 52 of the feedwell 22 and rotating paddles 92, shown in the form of elongated members, may be coupled to the paddle drive shaft 41. As noted above, the paddle drive shaft 41 is disposed about the rake arm drive shaft 38 and is configured to rotate independently thereof so as to enable the paddle drive shaft 41 and the rake arm drive shaft 38 to operate at independent rotational velocities.

The rotating paddles 92 thus rotate with the paddle drive shaft 41 and pass between the baffles 90 during their revolution about a central axis 93 of the feedwell 22. The rotational speed of the paddles 92 may be varied depending on various parameters including, for example, the type of influent slurry, the solids concentration of the slurry, and the desired intensity of mixing the slurry with the flocculating agent within the feedwell 22. An exemplary range of rotational speed may include approximately 1 to 5 revolutions per minute although other speeds may be utilized. As will be appreciated by those of ordinary skill in the art, the linear speed of the paddles 92 will vary depending on their respective distances from the axis of rotation.

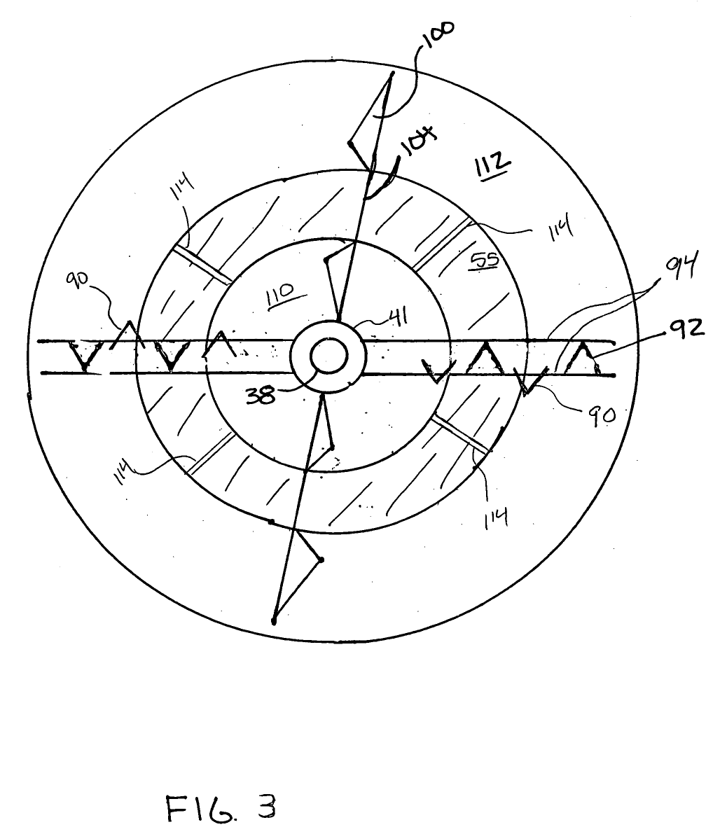

The baffles 90 may be configured to exhibit a desired cross-sectional shape such as, for example, cylindrical members, substantially flat plates, polygonal members, or other angled members. For example, in one embodiment, the baffles 90 may be formed of structural angle having two planar surfaces perpendicularly joined together along a common edge such as depicted in FIG. 3.

The baffles 90 may be oriented about a central axis 93 of the feedwell 22 as a single row of baffles 90 extending across the diameter of the feedwell, as shown in FIG. 3, or there may be multiple rows of baffles 90. Additionally, the baffles 90 may be positioned according to any other desired pattern, including a random pattern, depending of the desired flow and mixing characteristics within the feedwell 22. Furthermore, the baffles 90 need not all terminate at identical depths.

Referring back to FIG. 2, the rotating paddles 92 may also include elongated members with a desired cross-sectional shape or configuration. As with the baffles 90, while the paddles 92 are shown in a single row (see FIG. 3), any number of paddles 92 may be used and placed in various patterns and configurations. The paddles 92 may be affixed to the paddle drive shaft 41 by way of, for example, transversely extending structural cross-members 94.

Rotating cleansing scrapers 100 may also be fixed to the paddle drive shaft 41, such as by structural cross members 94. In another embodiment, the scrapers 100 may be fixed to the paddle drive shaft 41 by additional cross-members 104, such as shown in FIG. 3, so that the scrapers 100 are not located within the same vertical plane as the paddles 92. As shown in FIGS. 2 and 3, the scrapers 100 are configured and positioned to scrape the floor 54 of the feedwell 22 as they rotate about the central axis 93 of the feedwell 22. The scrapers 100 may be angled with respect to the floor 54 of the feedwell 22 for effective cleansing thereof. Additional scrapers 100 may also be positioned and configured to scrape and clear the walls 50 of settled floc.

Additionally, one or more paddles 92 may serve as cleansing scrapers if so desired. For example, the radially most outer paddles 92 may be positioned at a predefined distance from the interior surface of the side wall 50 to prevent floc build up thereon. Furthermore, one ore more paddles may have their lower ends 95 extend through the discharge opening or exit port 55 of the feedwell 22 to prevent bridging of the exit port 55 by a build-up of settled flocs. In another embodiment, rather than extending the paddles 92 through the exit port 55, cleansing scrapers 100 may be positioned and configured to prevent the bridging of the exit port 55 by settled flocs.

In one embodiment of the present invention, as shown in FIG. 2, the floor 54 of the feedwell 22 may be configured to define an annular, or ring-shaped, exit port 55. The floor 54 may thus formed of two separate sections, an inner floor section 110 and an outer floor section 112. The outer floor section 112 may be fixed to, and generally contiguous with, the side wall 50. The inner floor section 110 immediately surrounding the paddle drive shaft 41 may be coupled to the paddle drive shaft 41 and rotate therewith. In another embodiment, the inner floor section 110 may be coupled to the outer floor section 112 using structural members 114 which intermittently extend across the exit port 55. However, it is noted that in such a configuration, the lower ends 95 (FIG. 2) of the paddles 92 would not extend through the exit port 55 as the structural members 114 would interfere with the rotation of the paddles 92. Rather, the lower ends 95 of the paddles 92, or other scraper members, may terminate above but proximate to the elevation of the exit port 55.

Both the inner floor section 110 and the outer floor section 112 may slope downward toward the exit port 55. If the inner floor section is fixed to the paddle drive shaft 41, it may be desirable to form the inner floor section 110 at a relatively steeper angle than that of the outer floor section 112 since the scrapers 100 will not be effective in cleaning such a rotating floor section, there being no relative rotation between the inner floor section 112 and the scrapers 100 in such a case.

It is noted that the inner and outer floor sections 110 and 112 may exhibit other configurations than that which is shown in FIG. 2. For example, inner and/or outer floor sections 110 and 112 may be configured to be substantially flat. Furthermore, while shown to be at substantially similar elevations, the inner floor section 110 may be positioned at a higher or lower elevation than the outer floor section 112 depending, for example, and desired flow characteristics of the flocculated slurry as it is discharged from the feedwell 22.

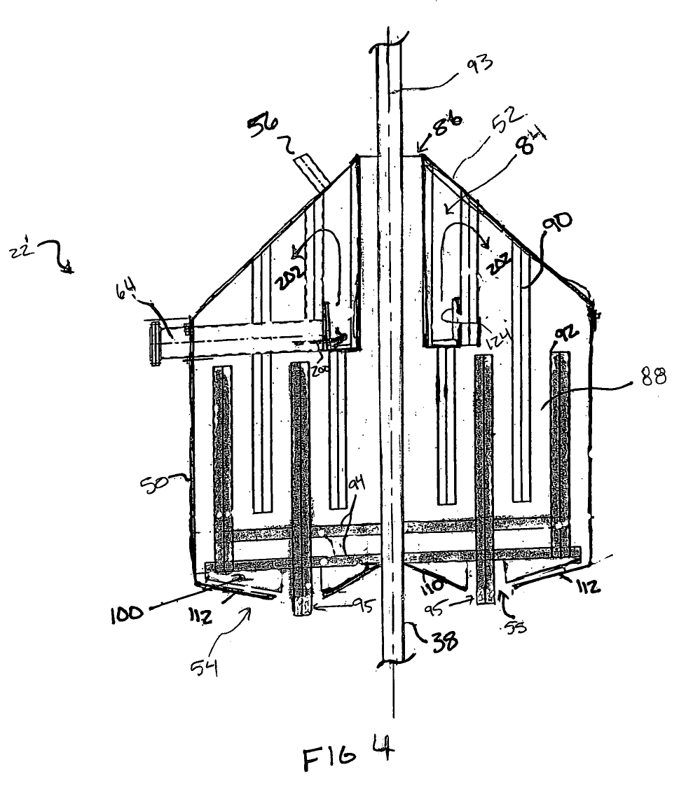

Referring now to FIG. 4, a feedwell 22′ according to another embodiment of the invention is shown. The feedwell 22′ is configured substantially similarly to the feedwell 22 shown and described with respect to FIG. 2, except that the rake arm drive shaft 38 also serves as the paddle drive shaft 41. Thus, paddles 92 and cleansing scrapers 100 may be coupled to the rake arm drive shaft 38 by way of extending structural cross-members 94′. Being fixed to the rake arm drive shaft 38, it is noted that the paddles 92 and cleansing scrapers 100 rotate at the same speed as drive shaft 38 and the rake arms 36 (FIG. 1).

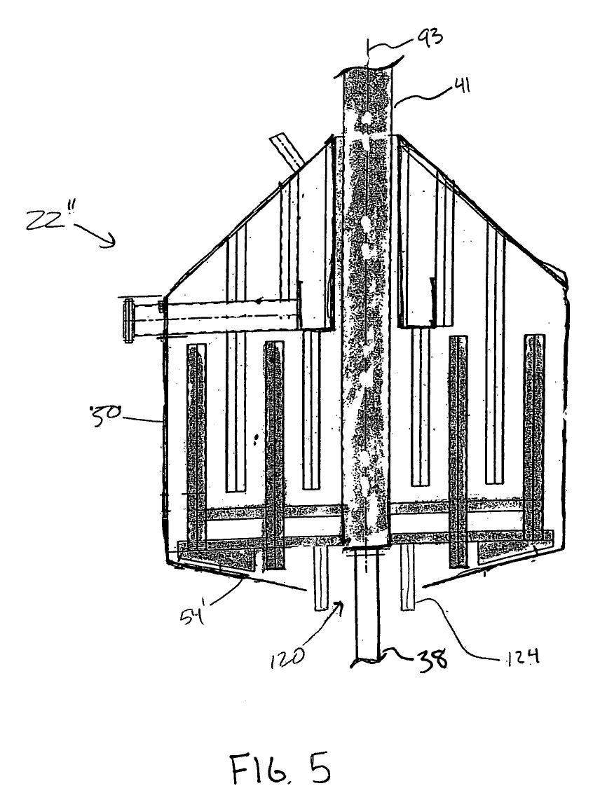

Referring briefly to FIG. 5, another embodiment of a feedwell 22″ is shown in accordance with the present invention. The feedwell 22″ is configured generally in accordance with that which is shown and described with respect to FIGS. 2 and 3, except that the floor 54′ of the feedwell 22 is formed of a single section. The floor 54′ slopes downward from outer wall 50 toward the central axis 93 of the feedwell 22″. A central opening 120 is formed in the floor 54′ as the exit port. Paddles 124 or cleansing scrapers may be configured to rotate about the central axis 93 of the feedwell 22″ and keep any settled flocs from building up and blocking the central opening 120.

In any of the embodiments of the present invention, the exit port 55, 120 is generally constricted relative to the main flocculation zone 88 of the feedwell 22, 22′, 22″ and thereby constricts flow of the slurry therethrough. Thus, for example, the exit port 55 or 120 may exhibit an area of approximately 5% to 30% of the cross-sectional area the main flocculation zone 88 of the feedwell 22, 22′, 22″ as taken transverse to the central axis 93 of the feedwell 22, 22′ and 22″. It is noted that the constricted nature of the exit port 55, 120 allows for greater control of the flow of the slurry through the feedwell 22, 22′, 22″. For example, the exit port 55, 120 may be sized and configured so as to maintain the discharge of the flocculated slurry within a desired velocity range such as, for example, 2 to 10 feet/minute depending on various factors such as, for example, the type and amount of flocculating agent being used, the type of slurry being processed and/or the solids concentration of the slurry.

Additionally, with regard to the embodiment shown and described with respect to FIGS. 2-4, the exit port 55 allows the location of the discharge of flocculated slurry to be displaced radially outwardly from the center of the clarifier which enables more efficient dispersement of the flocculated slurry within the clarifying or settling zone of the clarifier and ultimately promotes more efficient settling. For example, it may be desirable to configure and locate the exit port 55 such that the radial center of the exit port 55 is approximately midway between the central axis 93 of the feedwell 22, 22′ and the outer wall 50.

Moreover, the feedwell 22, 22′, 22″ of the present invention allows for extended residence time of the slurry within the feedwell 22, 22 ,22″ resulting in more complete mixing of the flocculating reagent with the slurry. It is noted, that for added control of the discharge into the clarifier tank 12 (FIG. 1), a fixed baffle 122 may be positioned below the exit port 55, as shown in FIG. 2, to disburse and direct the discharge from the feedwell 22.

Referring to FIGS. 1 and 2, in operation, influent feed slurry enters the feedwell 22 through the influent pipe or nozzle 64 as indicated by directional arrow 200. The slurry discharges into an internal feed distribution tub 124, which generally forms an annulus about, and is configured to disperse the influent feed slurry about, the circumference of the paddle drive shaft 41. The influent slurry may be discharged tangentially into the feed distribution tub 124 to help dissipate energy of the influent slurry stream. The influent slurry then flows upwardly from the internal feed distribution tub 124 into the upper generally frustoconical volume 84 of the feedwell 22 to further dissipate energy and then down into the main flocculation zone 88, as indicated by directional arrows 202 (FIG. 2), where rotating paddles 92 pass the stationary baffles 90 in an interleaved configuration. The motion of the rotating paddles 92, along with the cooperative arrangement of the baffles 90, creates mixing eddies within the slurry. The mixing eddies provide higher incidence of contact between suspended particles and flocculating reagent, further increasing floc size. Additionally, the rotating paddles 92 provide an even circumferential distribution of the stream within the feedwell 22.

The flocs move downward past the stationary baffles 90 to a zone below the baffles 90 offering reduced stimulation. While the rotating paddles 92 still enforce the circumferential distribution of the slurry stream in this zone of reduced stimulation, the energy of the slurry is dissipated and the fluid velocity is reduced. As noted above, any solids settling on the floor 54 or wall 50 of the feedwell 22 may be removed by scrapers 100 and pushed toward exit port 55. The slurry enters the clarification tank through exit port 55 and, due to the reduced energy of the slurry and the increased floc size, settling occurs more efficiently within the clarifier tank 10.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A feedwell for use in a clarifier tank, comprising:
a body defining a volume for flowing a slurry therethrough, the body including a side wall and a floor wherein the floor defines at least one opening therein for discharging the slurry and wherein the at least one opening is configured to constrict flow of the slurry;
at least one baffle disposed within the body in a fixed position relative thereto; and
at least one paddle located and configured to rotate within the body about a central axis of the body.

2. The feedwell of claim 1, wherein the body further comprises a top wall coupled to the side wall.

3. The feedwell of claim 2, wherein the top wall exhibits a substantially frustoconical shape.

4. The feedwell of claim 3, wherein the at least one baffle is fixed to the top wall.

5. The feedwell of claim 4, wherein the at least one paddle is configured for attachment to a drive shaft of a clarifier.

6. The feedwell of claim 5, further comprising at least one scraper located and configured to rotate about the central axis adjacent an interior surface of the floor.

7. The feedwell of claim 5, further comprising at least one scraper located and configured to rotate about the central axis adjacent an interior surface of the side wall.

8. The feedwell of claim 5, wherein the floor includes a first floor section and a second floor section spaced therefrom, the second floor section being disposed radially inwardly of the first floor section, the at least one opening being defined therebetween.

9. The feedwell of claim 1, further comprising at least one other baffle disposed beneath the at least one opening.

10. A feedwell for use in a clarifier tank comprising:
a body defining a volume for flowing a slurry therethrough, the body comprising:
a side wall;
a first floor section extending inwardly from the side wall toward a central axis of the body; and
a second floor section positioned radially inwardly of the first floor section, the second floor section extending outwardly from a location proximate the central axis of the body, wherein the first floor section and second floor section are configured to define at least one substantially annular opening therebetween.

11. The feedwell of claim 10, wherein the second floor section extends downwardly as it extends outwardly from the location proximate the central axis of the body.

12. The feedwell of claim 11, wherein the first floor section extends downwardly as it extends inwardly from the side wall.

13. The feedwell of claim 10, wherein the at least one substantially annular opening is configured to constrict flow of the slurry therethrough.

14. The feedwell of claim 10, further comprising at least one baffle fixed within the body.

15. The feedwell of claim 14, further comprising at least one paddle located and configured to rotate within the body about the central axis.

16. The feedwell of claim 15, further comprising at least one scraper located and configured to rotate about the central axis adjacent an interior surface of the floor.

17. The feedwell of claim 15, further comprising at least one scraper located and configured to rotate about the central axis adjacent an interior surface of the walled member.

18. The feedwell of claim 10, further comprising at least one baffle disposed beneath the at least one substantially annular opening.

19. A feedwell for use in a clarifier tank comprising:
a body defining a volume for flowing a slurry therethrough, the body including at least a side wall and a floor; and
at least one scraper relatively moveable with respect to the body, the at least one scraper being located and configured to remove an amount of built-up material deposited on an interior surface of the body.

20. The feedwell of claim 19, wherein the at least one scraper is located and configured to remove an amount of built-up material from an interior surface of the side wall.

21. The feedwell of claim 19, wherein the at least one scraper is located and configured to remove an amount of built-up material from an interior surface of the floor.

22. The feedwell of claim 19, further comprising at least one baffle fixed within the body.

23. The feedwell of claim 22, further comprising at least one paddle located and configured to rotate within the body about the central axis.

24. A clarifier comprising:
a tank configured to hold a volume of fluid therein;
a feedwell disposed at least partially within the tank, the feedwell comprising:
a body defining a volume for flowing a slurry therethrough, the body including at least a side wall and a floor coupled to the side wall wherein the floor defines at least one opening therein for discharging the slurry and wherein the at least one opening is configured to constrict flow of the slurry;
at least one baffle disposed within the body in a fixed position relative thereto;
at least one paddle located and configured to rotate about a central axis of the body; and
at least one scraper located and configured to rotate about a central axis of the body adjacent at least one interior surface of the body.

25. The clarifier of claim 24, further comprising at least one other baffle disposed beneath the at least one opening.
